(19) United States
(12) Patent Application Publication
(10) Pub. No.: US 2020/0014073 A1
(43) Pub. Date: Jan. 9, 2020

(54) METAL-ION BATTERY AND THE MANUFACTURING METHOD THEREOF

(71) Applicant: National Taiwan university of science and technology, Taipei City (TW)

(72) Inventor: HUNG-LUNG CHOU, Taipei City (TW)

(21) Appl. No.: 16/422,913

(22) Filed: May 24, 2019

(30) Foreign Application Priority Data
Jul. 6, 2018 (TW) 107123519

(51) Int. Cl. H01M 10/38; H01M 4/583

(52) U.S. Cl. CPC H01M 10/38; H01M 2004/028; H01M 4/583

(57) ABSTRACT

The present invention discloses a metal-ion battery and the manufacturing method thereof, which could effectively reduce or even inhibit the generation of gas such as chlorine (Cl₂) or hydrogen (H₂). The metal-ion battery comprises an anode, a cathode, and an electrolyte liquid. The cathode is an active material. The electrolyte liquid comprising at least one metal ion, an ionic liquid and a metal halide is disposed between the anode and the cathode. The at least one metal ion comprises copper ions, zinc ions or the combination thereof.

### TECHNICAL FIELD

The present invention relates to a metal-ion battery and the manufacturing method thereof, particularly, to a metal-ion battery capable of effectively reducing and inhibiting the generation of gas molecule and the manufacturing method thereof.

### BACKGROUND OF RELATED ARTS

Lithium ion battery is the most common type of charge-discharge battery. However, some deficiencies of the lithium-ion battery have been found, such as over-discharge/charge intolerance, which reduces the battery storage capacity and shortens battery life. Organic solvents are usually used as electrolytes in lithium-ion battery. When the battery is short-circuited, the internal thermal energy of lithium-ion battery will ignite ethers as solvents in a short time, and thereby causing safety problems of expansion and even explosion. Therefore, in order to reduce the risk of battery explosion and increase battery capacity, an aluminum ion battery is proposed in U.S. Pat. No. 1,583,038 of the Republic of China. Based-on low cost, low flammability and electronic oxidation-reduction characteristics of metal aluminum, aluminum ion battery can provide cost-effectiveness, high capacity and safety.

Aluminate chloride ion (AlCl₄⁻) with good conductivity and relatively stable is selected as the electrolyte of an aluminum ion battery. However, during the process of charging and discharging of aluminum ion battery, one of the chloride ion (Cl⁻) of aluminum chloride ion (AlCl₄⁻ or Al₂Cl₇⁻) will be inserted into the lattice of the cathode material. When chloride ions combine with each other, chlorine (Cl₂) or other gas molecules such as hydrogen (H₂) and oxygen (O₂) will be produced and released to the atmosphere for air pollution. Besides, in the process of manufacturing aluminum ion battery in the factory, it often needs to wait for the above gases generated by the chemical reaction of aluminum ion batteries to be dispersed before subsequently packaging, which quite wastes time cost.

### SUMMARY

To resolve the drawbacks of the prior arts, the present invention discloses a metal-ion battery and the manufacturing method thereof, which could effectively reduce or even inhibit the generation of gas such as chlorine (Cl₂) or hydrogen (H₂).

Based-on the above purpose, the present invention proposes a metal ion battery, comprising an anode; a cathode made of an active material; and an electrolyte liquid arranged between the anode and the cathode, wherein the electrolyte liquid comprises at least one metal ion, an ionic liquid and a metal halide; wherein the at least one metal ion includes a copper ion, a zinc ion or the combination thereof.

Further, a material of the anode is aluminum (Al), silver (Au), copper (Cu), iron (Fe), cobalt (Co), zinc (Zn), indium (In), cadmium (Cd), nickel (Ni), tin (Sn), chromium (Gr), lanthanum (La), yttrium (Y), titanium (Ti), manganese (Mn), tungsten (W), tantalum (Ta), molybdenum (Mo) or alloy consisted of the combination thereof.

Furthermore, wherein a material of the active material is graphite, graphene, carbon nanotubes or the combination thereof, and a material of the graphite includes natural graphite, artificial graphite, mesophase carbon microspheres mesocarbon microbead (MCMB), pyrolytic graphite, foamed graphite, flake graphite, or expanded graphite.

Further, the ionic liquid includes urea, N-methylurea, choline chloride, acetylcholine chloride, dimethyl sulfoxide, methylsulfonylmethane, alkyl-imidazolium salt, alkyl-pyridinium salt, alkyl-fluoropyrazolium salt, alkyl-triazolium salt, aralkyl-ammonium salt, alkyl-alkoxyammonium salt, aralkyl-phosphonium salt, aralkyl-sulfonium salt or the combination thereof.

Furthermore, the metal halide includes aluminum halide, silver halide, silver halide, copper halide, iron halide, cobalt halide, zinc halide, indium halide, cadmium halide, nickel halide, tin halide, chromium halide, lanthanum halide, yttrium halide, titanium halide, manganese halide, molybdenum halide or the combination thereof.

In addition, a method of manufacturing a metal ion battery, comprising (a) providing an aluminum foil with thickness between 10 and 300 microns, and cutting said aluminum foil to form an anode; (b) providing flake graphite as a cathode; (c) packaging the anode and the cathode and injecting an electrolyte liquid between the anode and the cathode, in which the electrolyte liquid comprises at least one metal ion, an ionic liquid and a metal halide; wherein the at least one metal ion includes a copper ion, a zinc ion or the combination thereof, and a weight percentage concentration of the at least one metal ion in the electrolyte liquid is between 10-65.

Embodiments of the invention are illustrated by way of example, and not by way of limitation, in the figures of the accompanying drawings in which like reference numerals refer to similar elements.

### BRIEF DESCRIPTION OF THE DRAWINGS

FIG. 1 is a schematic diagram of a metal ion battery of an embodiment of the present invention.

FIG. 2 is a picture of scanning electron micrograph of cathode graphite in an embodiment of the present invention.

FIG. 3 is a test diagram of current stability of a metal ion battery according to the first embodiment of the present invention.

FIG. 4 is a test diagram of battery efficiency of the metal ion battery in the first embodiment of the present invention.

FIG. 5 is a comparison diagram of the energy barrier of dissociation reaction of the electrolyte liquid between the present invention and the prior art.

### DETAILED DESCRIPTION OF THE INVENTION

In order to understand the technical features and practical efficacy of the present invention and to implement it in accordance with the contents of the specification, hereinafter, preferred embodiments of the present invention will be described in detail with reference to the accompanying drawings.

The present invention proposes a metal ion battery. According to the embodiment of the present invention, in the metal ion battery, a metal (or alloy) material is as an anode, an active material is as a cathode material, and an electrolyte liquid arranged between the anode and the cathode contains at least one metal ion, an ionic liquid and a metal halide. When the metal ion battery of the present invention is charged or discharged, the metal halide can be form into halogenated metal ions, such as aluminum chloride ion (AlCl₄⁻ or Al₂Cl₇⁻), and other halogenated metal ions different from aluminum chloride ions, so that the electrolyte liquid can be reversible during the reaction of intercalation and de-intercalation of the cathode. In addition, the present invention adds at least one metal ion, such as copper ion or zinc ion, in the electrolyte liquid to replace aluminum ion in the electrolyte liquid, and thereby reducing or even inhibiting the production of gas molecules such as chlorine (Cl₂), hydrogen (H₂) or oxygen (O₂).

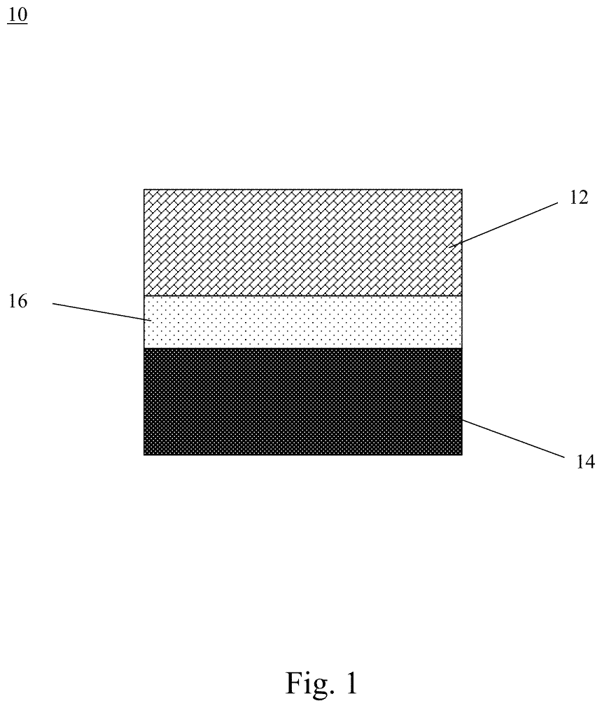

Please refer to FIG. 1, it illustrates a schematic diagram of a metal ion battery of an embodiment of the present invention. The metal ion battery 10 comprises an anode 12, a cathode 14 and an electrolyte liquid 16. The cathode 14 is made of an active material, and the electrolyte liquid 16 is arranged between the anode 12 and the cathode 14, so that the electrolyte liquid 16 is in contact with the anode 12 and the cathode 14. Further, the electrolyte liquid 16 comprises at least one metal ion, an ionic liquid and a metal halide, in which the at least one metal ion includes a copper ion, a zinc ion or the combination thereof.

The metal ion battery 10 of the proposed invention is a rechargeable secondary battery, and the disposable battery is also included in the invention.

In this embodiment, a material of the anode 12 may be aluminum (Al), silver (Au), copper (Cu), iron (Fe), cobalt (Co), zinc (Zn), indium (In), cadmium (Cd), nickel (Ni), tin (Sn), chromium (Gr), lanthanum (La), yttrium (Y), titanium (Ti), manganese (Mn), tungsten (W), tantalum (Ta), molybdenum (Mo) or alloy consisted of the combination thereof. In a preferred embodiment, a material of the anode 12 of the metal ion battery 10 is aluminum (Al). Furthermore, the anode 12 can also contain a first collector layer coated with the metal (or alloy). The first collector layer can be made of a conductive carbon base material such as carbon cloth, carbon felt, or carbon paper, with a carbon content greater than 80 wt % (weight percentage).

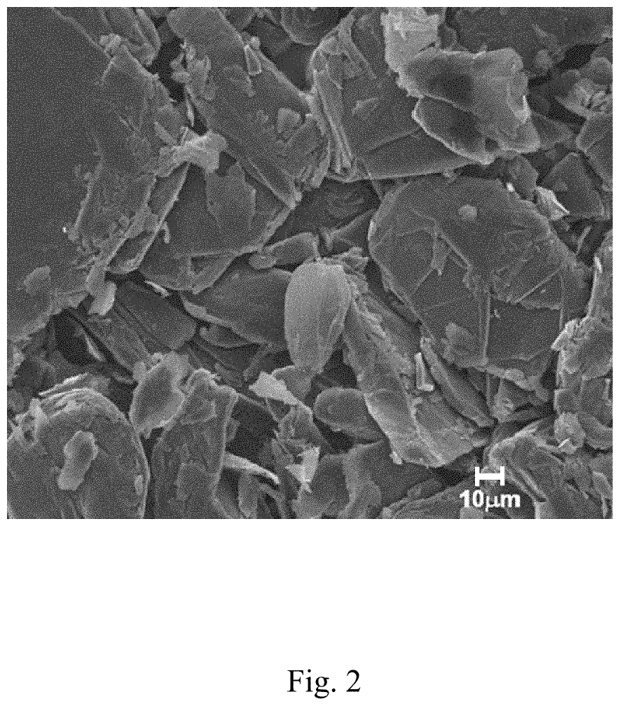

In this embodiment, an active material of the cathode 14 may be intercalated carbon material, such as graphite (including natural graphite, artificial graphite, mesophase carbon microspheres mesocarbon microbead (MCMB), pyrolytic graphite, foamed graphite, flake graphite, or expanded graphite), graphene, carbon nanotubes or the combination thereof. In some embodiments, the active material may be a layered double hydroxide, a layered oxide, a layered chalcogenide or the combination thereof. In a preferred embodiment, the active material of the cathode 14 of metal ion battery 10 is graphite shown in FIG. 2, which is a picture with a scale of 10 nanometers of scanning electron micrograph of cathode graphite in an embodiment of the present invention. Based-on the picture, it can be seen that the graphite surface shows an outline of sheets-stacking, so that the metal ion battery of the present invention has good conductivity.

Furthermore, the cathode 14 can also contain a second collector layer disposed on the active material. A material of the second collector layer can be a conductive carbon base material such as carbon cloth, carbon felt, or carbon paper, with a carbon content of more than 80 wt %. The connection between the active material and the second collector layer is that the active material grows directly on the second collector layer (that is, there is no medium therebetween), or the second collector layer is fixed (adhered) on the active material with an adhesive material.

In this embodiment, the electrolyte liquid 16 arranged between the metal (or alloy) anode 12 and the graphite cathode 14 comprises at least one metal ion, an ionic liquid and a metal halide.

In the electrolyte liquid 16, the ionic liquid is usually a room temperature ionic liquid (RTIL). For example, the ionic liquid includes urea, N-methylurea, choline chloride, acetylcholine chloride, dimethyl sulfoxide, methyl sulfonylmethane, alkyl-imidazolium salt, alkyl-pyridinium salt, alkyl-fluoropyrazolium salt, alkyl-triazolium salt, aralkyl-ammonium salt, alkyl-alkoxyammonium salt, aralkyl-phosphonium salt, aralkyl-sulfonium salt or the combination thereof. Furthermore, the electrolyte liquid 16 can also contain an additive to improve the conductivity of the electrolyte liquid and reduce the liquid viscosity.

In the electrolyte liquid 16, the metal halide includes metal fluoride, metal chloride, or metal bromide such that a reaction of the electrolyte liquid 16 keeps reversible. The metal halide includes aluminum halide, silver halide (such as silver fluoride, silver chloride or silver bromide), copper halide (such as copper fluoride, copper chloride or copper bromide), iron halide (such as iron fluoride, iron chloride or iron bromide), cobalt halide (such as cobalt fluoride, cobalt chloride or cobalt bromide), zinc halide (such as zinc fluoride, zinc chloride or zinc bromide), indium halide (such as indium fluoride, indium chloride or indium bromide), cadmium halide (such as cadmium fluoride, cadmium chloride or cadmium bromide), nickel halide (such as nickel fluoride, nickel chloride or nickel bromide), tin halide (such as tin fluoride, tin chloride or tin bromide), chromium halide (such as chromium fluoride, chromium chloride), lanthanum halide (such as lanthanum fluoride, lanthanum chloride or lanthanum bromide), yttrium halide (such as yttrium fluoride, yttrium chloride or yttrium bromide), titanium halide (such as titanium fluoride, titanium chloride, or titanium bromide), manganese halide (such as manganese fluoride, manganese chloride or bromide), molybdenum halide (such as molybdenum fluoride, molybdenum chloride or molybdenum bromide) or the combination thereof. Further, the metal halide of the present invention may have different positive valence of metal. For example, the chemical formula of copper chloride may be CuCl or CuCl₂, and the chemical formula of zinc chloride may be ZnCl₂ or ZnCl₄. When the metal ion battery 10 is charged or discharged, the metal halide will create halogenated metal acid radical. In a preferred embodiment, the metal halide in the electrolyte liquid 16 is aluminum chloride (AlCl₃), and when the metal ion battery 10 is charged or discharged, aluminum chloride (AlCl₃) forms aluminum chloride ion (AlCl₄⁻ or Al₂Cl₇⁻).

In the electrolyte liquid 16, the at least one metal ion is a copper ion, a zinc ion or the combination thereof. The weight percentage concentration of the at least one metal ion in the electrolyte liquid 16 of the present invention is between 10-65 (wt %). In a preferred case, the weight percentage concentration of the at least one metal ion in the electrolyte liquid 16 is between 10-15 (wt %). In another optimal embodiment, the weight percentage concentration of the at least one metal ion in the electrolyte liquid 16 is 13 (wt %). On the other hand, the at least one metal ion in electrolyte liquid 16 can be all copper ions, and the at least one metal ion can also be all zinc ions. In another preferred embodiment, the at least one metal ion contains both copper ion and zinc ion, and the molar ratio of copper ion to zinc ion is 1:1.

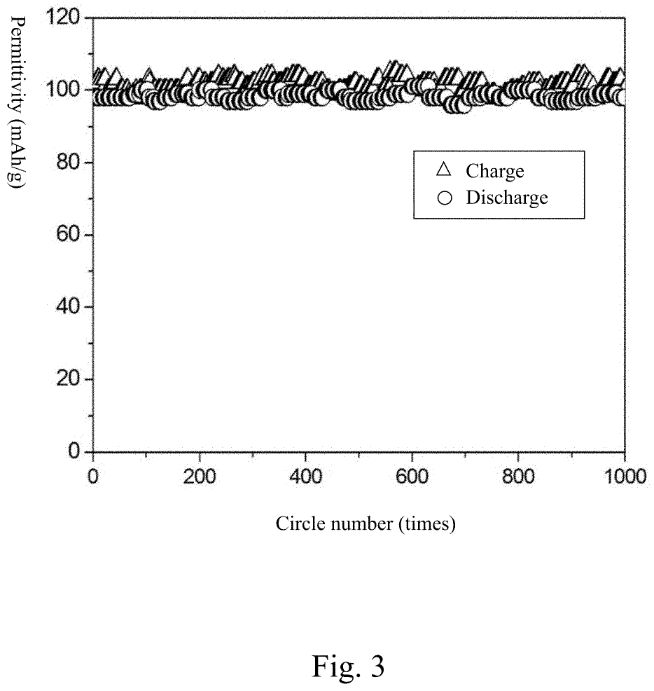

In aluminum ion battery, AlCl₃ with high conductivity and relatively stable is usually used as the electrolyte. In the process of charging and discharging, one of the chloride ion (Cl⁻) of aluminum chloride ion (AlCl₄⁻ or Al₂Cl₇⁻) formed by AlCl₃ will be inserted into the lattice of cathode graphite, and chloride ions (Cl⁻) will be inserted into the lattice of cathode graphite. In the process of chloride ions (Cl⁻) inserting into graphite lattice, the combination of chloride ions (Cl⁻) and graphite will generate chlorine (Cl₂) or other gas molecules such as hydrogen (H₂) or oxygen (O₂) and lead to safety concerns, and the subsequent assembly of aluminum ions needs to wait for the gas molecules to disperse. Therefore, the purpose of adding metal ions in the electrolyte liquids is to make chloride ions (Cl⁻) in the electrolyte liquid react with metal ions to reduce or even inhibit the production of gas molecules before they combine to form chlorine. According to the experiment's results, the best choice of metal ions in the electrolyte liquid is to include both copper ions and zinc ions. The molar ratio of copper ions to zinc ions is 1:1, and the weight percentage concentration of metal ions in the electrolyte liquid is 13 (wt %). Detailed experimental data of metal ion battery in the present invention can be referred to FIGS. 3, 4 and 5, and will be supplemented in subsequent paragraphs.

In addition, the invention also proposes a method for manufacturing metal ion battery. The processes of manufacturing are described as follows: First, in step (a), a metal foil with thickness between 10 and 300 microns is provided for cutting to form an anode, in which the metal foil is aluminum foil. Subsequently, in step (b), an active material such as graphite, graphene or nanotube is provided as a cathode, and in the best embodiment of the present invention, the active material is graphite. Then, in step (c), the aluminum foil electrode (as an anode) and the graphite electrode (as a cathode) are packaged and injected with electrolyte liquid between the anode and the cathode to form the metal ion battery of the invention, in which the electrolyte liquid comprises at least one metal ion, an ionic liquid and a metal halide.

In the electrolyte liquid, the metal halide contains the above-mentioned metal fluoride, metal chloride, or metal bromide, so that the electrolyte liquid maintains a reversible reaction. In this embodiment, the metal halide is aluminum chloride (AlCl₃).

In an electrolyte liquid, the ionic liquid can be liquid aqueous solution including urea, N-methylurea, choline chloride, acetylcholine chloride, etc., and the electrolyte liquid can also contain an additive to improve the conductivity of the electrolyte liquid and reduce the liquid viscosity. In this embodiment, the ionic liquid is an aqueous solution including 1-ethyl-3-methylimidazolium chloride.

In an electrolyte liquid, the at least one metal ion is a copper ion, a zinc ion or the combination thereof. The weight percentage concentration of the at least one metal ion in the electrolyte liquid of the present invention is between 10-65 (wt %); in a preferred embodiment, the weight percentage concentration of the at least one metal ion in the electrolyte liquid is between 10-15 (wt %) and in the best embodiment, the weight percentage concentration of the at least one metal ion in the electrolyte liquid is 13 (wt %). On the other hand, the at least one metal ion in the electrolyte liquid can be all copper ions, the at least one metal ion can also be all zinc ions, and the at least one metal ion contains both copper ions and zinc ions, and the molar ratio of copper ions to zinc ions is 1:1.

The metal ion battery according to the specific embodiments of the present invention will be described in detail below, but the scope of the implementation of the present invention is not to be limited accordingly.

### First Embodiment

First, in step (a), an aluminum foil with thickness between 10 and 300 microns is provided for cutting to form an anode. Subsequently, in step (b), graphite is provided as an active material of a cathode. Then, in step (c), the aluminum foil electrode (as an anode) and the graphite electrode (as a cathode) are packaged and injected with electrolyte liquid between the anode and the cathode to form the metal ion battery of the invention, in which the electrolyte liquid comprises at least one metal ion, an ionic liquid and a metal halide.

In this embodiment, the metal halide is aluminum chloride (AlCl₃), and the ionic liquid is an aqueous solution including 1-ethyl-3-methylimidazolium chloride. The at least one metal ion contains both copper ions and zinc ions, and the molar ratio of copper ions to zinc ions is 1:1, and the weight percentage concentration of the at least one metal ion in the electrolyte liquid is between 10-15 (wt %).

### Second Embodiment

First, in step (a), an aluminum foil with thickness between 10 and 300 microns is provided for cutting to form an anode. Subsequently, in step (b), graphite is provided as an active material of a cathode. Then, in step (c), the aluminum foil electrode (as an anode) and the graphite electrode (as a cathode) are packaged and injected with electrolyte liquid between the anode and the cathode to form the metal ion battery of the invention, in which the electrolyte liquid comprises at least one metal ion, an ionic liquid and a metal halide.

In this embodiment, the metal halide is aluminum chloride (AlCl₃), and the ionic liquid is an aqueous solution including 1-ethyl-3-methylimidazolium chloride. The metal ion only contains copper ions, and the weight percentage concentration of the metal ion in the electrolyte liquid is between 10-15 (wt %).

### Third Embodiment

First, in step (a), an aluminum foil with thickness between 10 and 300 microns is provided for cutting to form an anode. Subsequently, in step (b), graphite is provided as an active material of a cathode. Then, in step (c), the aluminum foil electrode (as an anode) and the graphite electrode (as a cathode) are packaged and injected with electrolyte liquid between the anode and the cathode to form the metal ion battery of the invention, in which the electrolyte liquid comprises at least one metal ion, an ionic liquid and a metal halide.

In this embodiment, the metal halide is aluminum chloride (AlCl₃), and the ionic liquid is an aqueous solution including 1-ethyl-3-methylimidazolium chloride. The metal ion only contains zinc ions, and the weight percentage concentration of the metal ion in the electrolyte liquid is between 10-15 (wt %).

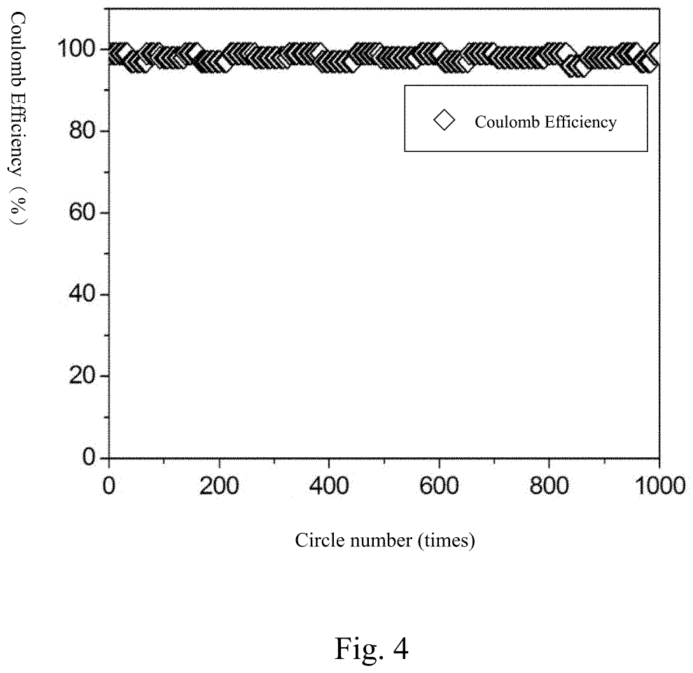

The current stability and battery efficiency of the metal ion battery according to the first embodiment of the present invention are measured by a battery analyzer. Referring to FIG. 3, it is a test diagram of current stability of a metal ion battery according to the first embodiment of the present invention. During the experiments, the charge and discharge tests of the metal ion battery are carried out 1000 times under the condition of current density of 198 (mA/g), and their charging and discharging voltages are recorded separately. Based-on FIG. 3, it can be seen that the permittivity of charging and discharging of the metal ion battery in the first embodiment of the present invention is maintained at about 100 (mAh/g). It can be seen that the metal ion battery in the first embodiment of the present invention is maintained at about 100 (mAh/g), and thus it has good battery characteristics. FIG. 4 is a test diagram of battery efficiency of the metal ion battery in the first embodiment of the present invention, and the stability test of the metal ion battery is also performed under the condition of current density of 198 (mA/g). Based-on FIG. 4, it can be seen that coulomb efficiency of the metal ion battery in the first embodiment of the present invention is stable and has quite excellent battery efficiency.

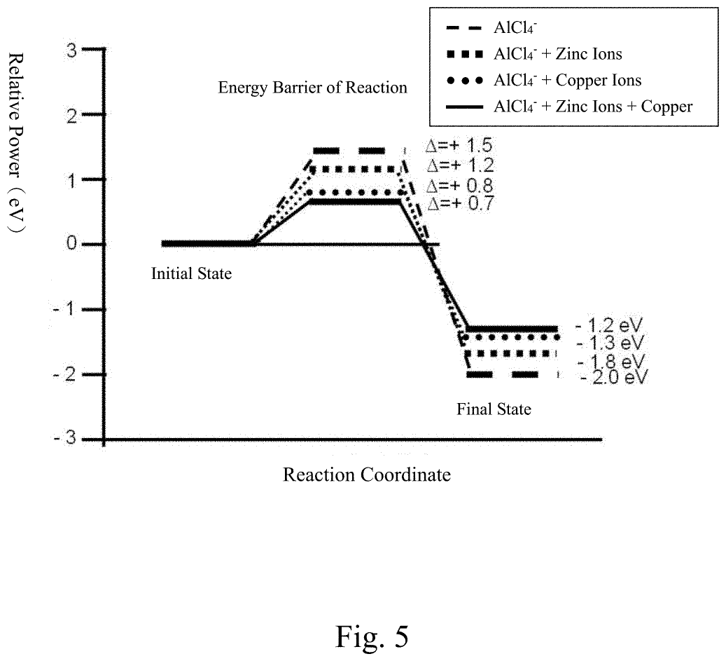

Finally, referring to FIG. 5, it illustrates a comparison diagram of the energy barrier of dissociation reaction of the electrolyte liquid between the present invention and the prior art. It can be clearly seen from FIG. 5 that the reaction energy barrier of dissociation reaction is 1.5 (eV) under the condition that the electrolyte liquid of an aluminum ion battery contains only aluminum chloride ion (AlCl₄⁻). While the metal ion battery of the first embodiment of the present invention (adding both copper ions and zinc ions in the electrolyte liquid) is applied, it can make the energy barrier of dissociation reaction in the electrolyte liquid reducing to 0.7 (eV); the metal ion battery of the second embodiment of the present invention (different from the first embodiment, adding only copper ions in the electrolyte liquid) is applied, the energy barrier of dissociation reaction in the electrolyte liquid can be reduced to 0.8 (eV); and the metal ion battery of the third embodiment of the present invention (different from the first embodiment, adding only zinc ions in the electrolyte liquid), the energy barrier of dissociation reaction in the electrolyte liquid can be reduced to 1.2 (eV). Therefore, adding metal ions (copper ions, zinc ions or their combination) into electrolyte liquid can effectively reduce the reaction energy barrier of dissociation reaction in the electrolyte liquid, reduce or even inhibit the generation of gas molecules in the reaction process, and thereby improving the safety of metal ion battery and greatly reducing the operation time in the manufacturing process of batteries.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A metal ion battery, comprising:
an anode;
a cathode made of an active material; and
an electrolyte liquid arranged between said anode and said cathode, wherein said electrolyte liquid comprises at least one metal ion, an ionic liquid and a metal halide;
wherein said at least one metal ion includes a copper ion, a zinc ion or the combination thereof.

2. The metal ion battery of claim 1, wherein a material of said anode is aluminum (Al), silver (Au), copper (Cu), iron (Fe), cobalt (Co), zinc (Zn), indium (In), cadmium (Cd), nickel (Ni), tin (Sn), chromium (Gr), lanthanum (La), yttrium (Y), titanium (Ti), manganese (Mn), tungsten (W), tantalum (Ta), molybdenum (Mo) or alloy consisted of the combination thereof.

3. The metal ion battery of claim 1, wherein a material of said active material is graphite, graphene, carbon nanotubes or the combination thereof.

4. The metal ion battery of claim 3, wherein a material of said graphite includes natural graphite, artificial graphite, mesophase carbon microspheres mesocarbon microbead (MCMB), pyrolytic graphite, foamed graphite, flake graphite, or expanded graphite.

5. The metal ion battery of claim 1, wherein said ionic liquid includes urea, N-methylurea, choline chloride, acetylcholine chloride, dimethyl sulfoxide, methyl sulfonylmethane, alkyl-imidazolium salt, alkyl-pyridinium salt, alkyl-fluoropyrazolium salt, alkyl-triazolium salt, aralkyl-ammonium salt, alkyl-alkoxyammonium salt, aralkyl-phosphonium salt, aralkyl-sulfonium salt or the combination thereof.

6. The metal ion battery of claim 1, wherein said metal halide includes aluminum halide, silver halide, silver halide, copper halide, iron halide, cobalt halide, zinc halide, indium halide, cadmium halide, nickel halide, tin halide, chromium halide, lanthanum halide, yttrium halide, titanium halide, manganese halide, molybdenum halide or the combination thereof.

7. The metal ion battery of claim 1, wherein a weight percentage concentration of said at least one metal ion in said electrolyte liquid is between 10-65.

8. The metal ion battery of claim 1, wherein a weight percentage concentration of said at least one metal ion in said electrolyte liquid is between 10-15.

9. The metal ion battery of claim 1, wherein molar ratio of said copper ion to said zinc ion is 1:1.

10. A method of manufacturing a metal ion battery, comprising:
providing an aluminum foil with thickness between 10 and 300 microns, and cutting said aluminum foil to form an anode;
providing graphite as a cathode;
packaging said anode and said cathode and injecting an electrolyte liquid between said anode and said cathode, in which said electrolyte liquid comprises at least one metal ion, an ionic liquid and a metal halide;
wherein said at least one metal ion includes a copper ion, a zinc ion or the combination thereof, and a weight percentage concentration of said at least one metal ion in said electrolyte liquid is between 10-65.
